(19) United States
(12) Patent Application Publication
(10) Pub. No.: US 2026/0344751 A1
(43) Pub. Date: Nov. 5, 2026

(54) ATOMIZING ELECTRONIC CIGARETTE

(71) Applicant: Julien BOILOT, CROISSY SUR SEINE (FR)

(72) Inventor: Julien BOILOT, CROISSY SUR SEINE (FR)

(21) Appl. No.: 19/124,721

(22) PCT Filed: Oct. 25, 2023
(86) PCT No.: PCT/EP2023/079799

§ 371 Date: Apr. 25, 2025

(30) Foreign Application Priority Data
Oct. 25, 2022 (FR) FR2211043

(51) Int. Cl. A24F 40/05; A24F 40/10; A24F 40/44; A24F 40/485; B05B 17/06

(52) U.S. Cl. CPC A24F 40/05; A24F 40/10; A24F 40/44; A24F 40/485; B05B 17/0653

(57) ABSTRACT

An electronic cigarette is configured to atomize, by a vibrating membrane, a liquid contained in a reservoir. The electronic cigarette includes a chamber disposed between the reservoir and the membrane, the chamber extending between two parallel walls, of which one is formed by a face of the membrane, the liquid wetting the two walls of the chamber, a thickness of the chamber, forming a distance separating the two walls, being defined so that the liquid diffuses in the chamber by a capillary action effect such that the liquid is held in contact with the membrane.

### CROSS-REFERENCE TO RELATED APPLICATIONS

This application is a National Stage of International patent application PCT/EP 2023/079799, filed on Oct. 25, 2023, which claims priority to foreign French patent application No. FR 2211043, filed on Oct. 25, 2022, the disclosures of which are incorporated by reference in their entireties.

### FIELD OF THE INVENTION

The invention relates to an electronic cigarette for simulating a conventional cigarette in which tobacco is consumed.

### BACKGROUND

Most current electronic cigarettes vaporize a liquid contained in a cartridge in order to generate the vapor inhaled by a user, allowing them to simulate smoking. The vaporization is obtained by heating the liquid by means of an electrical resistor immersed in the liquid. Through the Joule heating effect, the resistor dissipates heat in the liquid, which vaporizes. The vapor thus obtained can be sucked in by the user.

Resistance heating has several drawbacks. First of all, the vaporization greatly increases the temperature of the liquid before being sucked in by the user. The liquid, once vaporized, can reach temperatures much greater than 100 °C Certain manufacturers provide electronic cigarettes in which the sucked-in products reach temperatures of the order of 350 °C. At these temperatures, the additives present in the vaporized liquid can be denatured. Their chemical composition can notably be modified, possibly leading to a modification of the flavor experienced by the user.

Moreover, achieving the vaporization leads to a significant consumption of energy in order to increase the temperature of the liquid and to provide it with its latent heat of transformation from the liquid state to the gas state. Electronic cigarettes are equipped with a battery supplying power to the heating resistor that vaporizes the liquid. The battery has to be dimensioned sufficiently for the user to obtain acceptable autonomy. The significant energy expenditure of the resistor imposes a bulkiness and a significant mass of the battery.

In order to avoid vaporizing the liquid sucked in by the user, the inventor has developed a first electronic cigarette model, a description of which has been published in document WO 2021/094602 A1. In that document, it is specified that the liquid present in a reservoir is disposed in contact with a porous membrane that is able to vibrate in order to atomize the liquid. By avoiding vaporization, the energy consumption of the electronic cigarette is reduced since it is not necessary to heat the liquid in order to cause it to pass from its liquid phase to its gas phase. In that document, the presence of a capillary element for draining the liquid contained in the reservoir toward the membrane is described. This capillary element occupies part of the volume of the reservoir, thus correspondingly reducing the useful volume of the reservoir.

### SUMMARY OF THE INVENTION

The invention aims to overcome all or some of the problems cited above by providing an atomizing electronic cigarette in which the liquid is held in contact with the membrane without using a capillary element.

To this end, the invention relates to an electronic cigarette comprising:
a reservoir containing a liquid capable of being atomized,
a porous membrane configured to atomize the liquid, the membrane having the shape of a film having two opposite faces that are distant from one another by the thickness of the membrane, the liquid present in the reservoir coming into contact with a first of the two faces in order to pass through the membrane in its thickness,
an actuator configured to cause the membrane to vibrate so as to atomize the liquid as it passes through the membrane,
a chamber disposed between the reservoir and the membrane, the chamber being in communication with the reservoir in order to admit the liquid therein, the chamber extending between two parallel walls, of which a first is formed by the first face, the liquid wetting the two walls of the chamber, a thickness of the chamber, forming a distance separating the two walls, being defined so that the liquid diffuses in the chamber by a capillary action effect such that the liquid is held in contact with the membrane, the chamber being in communication with the reservoir by means of an orifice situated facing a central zone of the membrane.

A vertical orientation of the electronic cigarette is defined with respect to a user in a standing position drawing in the liquid atomized by the membrane, and, advantageously, in the vertical orientation:
the chamber and the membrane extend substantially vertically,
the chamber is in communication with the reservoir by means of an orifice opening at the lowest part of the reservoir.

Advantageously, the chamber has a washer shape extending around the orifice.

Advantageously, the chamber has a circular contour and the orifice has a circular section that is concentric with the circular contour of the chamber.

Advantageously, the actuator is fastened to the membrane and the actuator is pierced in the same dimensions as those of a section of the orifice.

### BRIEF DESCRIPTION OF THE DRAWINGS

The invention will be better understood and other advantages will become apparent on reading the detailed description of an embodiment given by way of example, which description is illustrated by the appended drawing, in which:

FIG. 1 shows, in section and in perspective, an example of an electronic cigarette according to the invention;

FIG. 2 shows, in section and in perspective, a partial view of the cigarette in FIG. 1 in the region of a liquid reservoir;

FIGS. 3a and 3b show, in a first orientation, with respect to a vertical direction, the part of the electronic cigarette shown in FIG. 2;

FIGS. 4a and 4b show, in a second orientation, with respect to a vertical direction, the part of the electronic cigarette shown in FIG. 2.

For the sake of clarity, the same elements will bear the same reference signs in the various figures.

### DETAILED DESCRIPTION

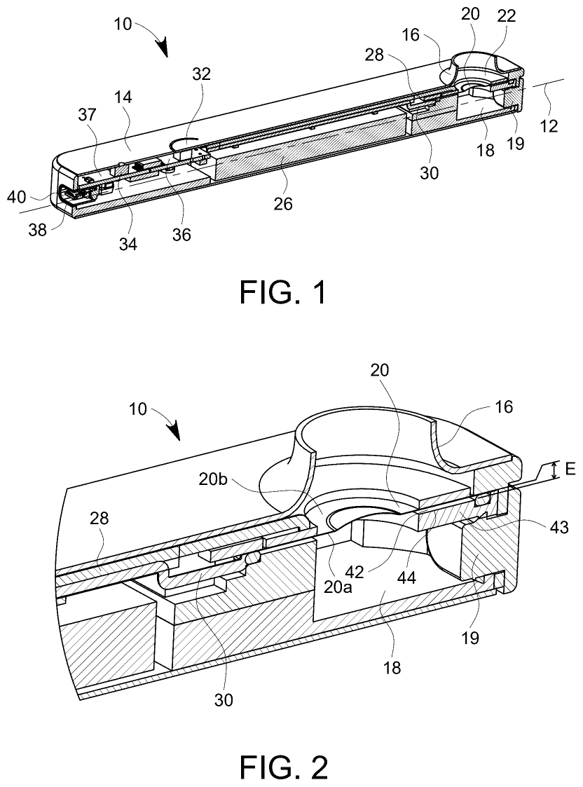

FIG. 1 shows an example of an electronic cigarette 10 of elongate shape, extending mainly along a longitudinal axis 12. In the example shown, the electronic cigarette 10 has a shell 14 of substantially rectangular section perpendicularly to the longitudinal axis 12 apart from a protruding endpiece 16 which a user can bring to their mouth in order to draw in a liquid atomized by the electronic cigarette 10. Any other shape of shell 14 is of course possible within the context of the invention.

The cigarette 10 comprises a reservoir 18 containing a product in liquid form that is intended to be atomized in order to be sucked in by a user through the endpiece 16. The reservoir 18 is closed by a removable plug 19 which makes it possible to fill the reservoir 18. The cigarette 10 also comprises a membrane 20 and an actuator 22 configured to cause the membrane 20 to vibrate. The membrane 20 is porous in order to allow the liquid to pass through in the form of a mist. The liquid remains in the liquid phase when it passes through the membrane 20. On exiting the membrane 20, the liquid is in the form of liquid droplets, the characteristic dimension of which is of the order of 1 to 10 μm. The membrane 20 is perforated with orifices having a section of the dimension of the droplets. More specifically, the membrane 20 has the shape of a flat film having two opposite faces 20a and 20b that are distant from one another by the thickness of the membrane 20. In the example shown, the membrane 20 extends mainly parallel to the axis 12. It is possible to arrange the membrane in other orientations, notably perpendicularly to the axis 12. The liquid present in the reservoir 18 comes into contact with the face 20a in order to pass through the membrane 20 in its thickness. The vibration of the membrane 20 effected by the actuator 22 leads to the liquid passing through the membrane 20. The vibration of the membrane 20 leads to its deformation, mainly perpendicularly to its thickness. In the example shown, the membrane 20 has a circular contour. Other membrane shapes are possible within the context of the invention. For a membrane 20 with a diameter of the order of 20 mm, a vibration at an ultrasonic frequency makes it possible to obtain the desired atomization. In-house tests have shown that a frequency of 30 kHz makes it possible to properly atomize the liquid. For the liquid, the fact it passes through the membrane 20 in its thickness makes it possible to limit the energy necessary for the atomization. The small thickness of the membrane offers only little resistance to the passage of the liquid. Once it has passed through the membrane 20, the atomized liquid disperses inside the endpiece 16 in order to be sucked in by the user.

The actuator 22 may be powered electrically. The power supply may be outside the cigarette 10. However, in order for the user to be able to use the cigarette 10 autonomously, the cigarette 10 is equipped with a battery 26 for supplying power to the actuator 22. Connecting wires 28 and 30 connect the battery 26 and the actuator 22. In the example in FIG. 1, the actuator 22 is a piezoelectric actuator. This type of actuator is well adapted to ultrasonic frequencies. The actuator 22 in this case has the shape of a washer pierced at its center in order to allow the membrane 20 to vibrate freely. Other types of actuators for causing the membrane to vibrate may be used within the context of the invention.

The power supply of the actuator 22 by the battery 26 may be controlled by means of a switch 32 operated by the user when they desire to use the cigarette 10. As an alternative or in addition to the switch 32, the power supply of the actuator 22 may be controlled when the user sucks on the cigarette 10. Such suction may be detected by means of a pressure sensor 34 configured to detect the suction of the user. More specifically, the pressure sensor 34 is disposed in a chamber 36 of the cigarette 10, in which the pressure drops when the user sucks on the cigarette 10 by way of the endpiece 16. In addition to the pressure sensor 34, the cigarette 10 comprises an electronic circuit 37 receiving information from the pressure sensor 34 and controlling the actuator 22 as a function of the information received from the pressure sensor 34. The electronic circuit 37 may comprise a comparator connected to the pressure sensor 34 at one of its inputs and to a reference voltage at the other of its inputs. The reference voltage is representative of the pressure below which the actuator 22 has to be operated.

The output of the comparator delivers a binary signal as a function of the sign of the difference between the signal received from the pressure sensor 34 and the reference voltage. As an alternative, the electronic circuit 37 may comprise a processor for example included in a microcontroller and carrying out the comparison operation described by means of the comparator. The benefit of the implementation of a processor is that it can also perform other tasks such as monitoring the state of charge of the battery 26, monitoring the level of liquid in the reservoir 18, etc. The electronic circuit 37 may be realized on a printed circuit board. The pressure sensor 34 may be soldered to the printed circuit board.

The cigarette 10 may comprise a connector 38 for example fastened to the electronic circuit 37 and making it possible to recharge the battery 26 and to communicate with the electronic circuit 37.

The cigarette 10 comprises an orifice 40 which makes it possible for outside air to reach the chamber 36 in which the pressure sensor 34 is situated. It is possible to use the functional play between the connector 38 and the shell 14 as orifice 40. Once inside the shell 14, the air bypasses the electronic circuit 37 and the battery 26 in order to reach the inside of the endpiece 16 forming a chamber in which the air is mixed with the atomized liquid.

FIG. 2 shows a partial, enlarged view of the electronic cigarette 10 in the region of the reservoir 18, the membrane 20 and the endpiece 16.

Between the reservoir 18 and the membrane 20, the cigarette 10 comprises a chamber 42 in communication with the reservoir 18. The chamber 42 is dimensioned so as to hold the liquid present in the reservoir 18 in contact with the membrane 20, dispensing with a capillary element as described in document WO 2021/094602 A1.

The chamber 42 extends along the membrane 20. The chamber 42 comprises two parallel walls. The face 20a of the membrane 20 forms one of the walls of the chamber 42. The other wall of the chamber 42, parallel to the face 20 a, bears the reference 44 and is for example produced in a body 43 of the cigarette 10 of which part separates the chamber 42 from the reservoir 18. The liquid and the walls 20a and 44 are defined such that the liquid wets the walls. In other words, in the presence of air at atmospheric pressure, the contact angle of a drop of liquid placed on a horizontal surface formed by the wall in question has a contact angle of less than 90°. This contact angle is dependent on the surface tension of the liquid at the interface with the air and on the nature of the walls 20a and 44. The thickness E of the chamber 42 is defined with respect to the face 20a. The thickness E is therefore the distance separating the face 20a and the wall 44. The thickness E is defined so that the liquid diffuses in the chamber by a capillary action effect. The chamber 42 has an essentially planar shape along a plane 45 passing between the two walls 20a and 44. The thickness E is defined perpendicularly to the plane 45.

The liquid may, for example, be water-based and contain additives, notably nicotine and flavorings. In-house tests have shown that a water-based liquid provides good atomization results with a membrane 20 pierced with orifices having a section of the order of a few microns. Other bases of liquid are also possible, for example glycerin-based. The section of the orifices in the membrane 20 is then adapted to the liquid in order to enable its atomization. It is possible to produce a stainless steel membrane 20. This type of membrane has a good service life. Other materials are possible for producing the membrane. A water-based liquid properly wets a stainless steel wall 20a.

In the example shown, the other wall 44 of the chamber 42 is produced in the body 43 of the cigarette 10. The body 43 may be made of plastics material. Several materials have been tested with success regarding their proper wettability in contact with a water-based liquid, notably acrylonitrile butadiene styrene known by its acronym ABS, polyethylene (PE), polyoxymethylene (POM), etc. Metal materials, notably aluminum-based alloys, may also be implemented. In practice, it is possible to produce the body 43 of the cigarette 10 from a material which makes it possible to facilitate its production and to cover it with a coating ensuring good wettability with the retained liquid. In addition, among the additives added to the base of the liquid, it is possible to select certain ones which improve the wettability of the liquid with respect to the walls 20a and 44.

For example for a water-based liquid, it is possible to add to it a solvent based on organic carbonates, some of which are known to improve the wettability of water.

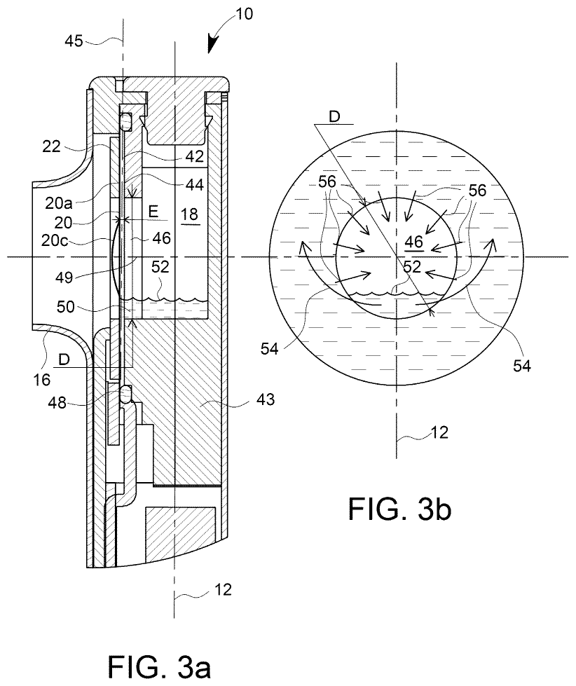

FIG. 3a shows the part of the electronic cigarette shown in FIG. 2 in section in a plane perpendicular to the plane in which the membrane 20 extends. The chamber 42 is in communication with the reservoir 18 by means of an orifice 46 for example situated facing a central zone 20c of the membrane 20. Thus, in this central zone 20c, the membrane 20 is not impaired in terms of its oscillatory movements when the actuator 22 causes the membrane 20 to vibrate. In other words, the central zone 20c cannot touch the walls of the chamber 42 during the oscillation of the membrane. The chamber 42 has, for example, a circular outer contour 48 in this case formed by a seal disposed between the membrane 20 and the body 43 of the cigarette 10. Other shapes of outer contours are possible for the chamber 42. The outer contour 48 extends in the plane 45. The orifice 46 then has a section parallel to the plane 45 that is also circular and concentric with the contour 48 of the chamber 42. The chamber 42 extends in the shape of a washer between the walls 20a and 44 around the central zone 20c. The orifice 46 may have other section shapes, notably polygonal, oval, etc. The orifice 46 advantageously has a tubular shape, the axis 49 of which is perpendicular to the plane 45. The section of the orifice 46 along the axis 49 is then constant.

The inner contour of the chamber 42 is formed by the orifice 46. Thus, the chamber extends at the periphery of the orifice 46. The thickness E of the chamber 42 remains stable, in other words substantially constant, in order to limit the disruption of the circulation of the liquid by the capillary action effect in the chamber 42 when the membrane 20 oscillates.

In addition, in the example shown, the bore in the actuator 22 has the same radial dimensions about the axis 49 as those of the orifice 46. More specifically, it is possible to select an actuator 22 having a circular bore and an orifice 46 of circular section, both with the same diameter D defined parallel to the plane 45. The actuator 22 may be fastened to the membrane 20 and stiffen the membrane 20 around its central zone 20c. Thus, the presence and the dimensions of the actuator 22 also make it possible to improve the stability of the thickness E of the chamber 42 during oscillations of the membrane 20.

The user may manipulate the cigarette 10 such that the longitudinal axis 12 is oriented in any direction with respect to a vertical direction. When a user in a standing position sucks the atomized liquid through the endpiece 16, the longitudinal axis 12 is in a substantially vertical position. Hereinafter, this orientation of the cigarette 10 is called vertical. In this position, due to gravity, the liquid 50 is in a low position in the reservoir 18 and communicates with the chamber 42 in the part thereof situated below the level 52 of the liquid 50. By capillary action effect, the liquid diffuses throughout the chamber 42, notably rising counter to gravity all the way around the central zone 20c of the membrane FIG. 3b shows the chamber 42 in the plane 45 parallel to the walls 20a and 44. Distinguished therein are the orifice 46 in the center and the level 52 of the liquid above the lowest level of the orifice 46 in the vertical orientation of the cigarette 10 shown in FIG. 3a. Arrows 54 show the rise of the liquid in the chamber 42 counter to gravity by the capillary action effect.

In FIGS. 3a and 3b, the level 52 of the liquid 50 has been shown at the bottom of the reservoir 18. In other words, the reservoir 18 is almost empty. Even with this very low level of liquid 50, the latter is in contact with the chamber 42 and can diffuse throughout the chamber 42 by the capillary action effect.

Movements of the user that cause the cigarette 10 to oscillate around its vertical orientation shown in FIGS. 3a and 3b allow the liquid 50 to move in the reservoir 18 and periodically enter the orifice 46 placing the liquid 50 in contact with the chamber 42. This placing in contact, even if temporary, allows the liquid to diffuse in the chamber 42. The capillary action effect allows the liquid 50 to stay in the chamber 42 even when the cigarette 10 is inclined such that the liquid 50 does not immerse the orifice 46.

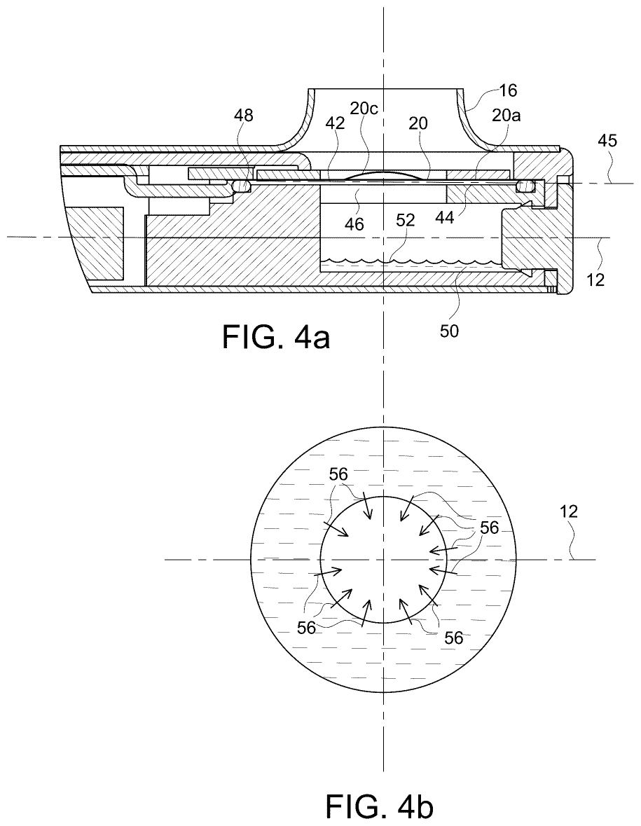

FIGS. 4a and 4b show the cigarette 10 in what is referred to as a horizontal orientation, as opposed to the vertical orientation of the cigarette 10 shown in FIGS. 3a and 3b. In the horizontal orientation, the axis 12 and the plane 45 are horizontal. The level 52 of the liquid 50 is parallel to the plane 45 due to gravity. The horizontal orientation of the cigarette 10 does not allow the liquid 50 contained in the reservoir 18 to reach the chamber 42 through the orifice 46. However, even in this orientation, liquid 50 stays inside the chamber 42.

During vibrations of the membrane 20 that are implemented to atomize the liquid 50, the central zone 20c of the membrane 20 is supplied with liquid by liquid present throughout the chamber 42, that is to say along the entire periphery of the membrane 20. This supply of the membrane 20 with liquid 50 is homogeneous and ensures atomization through the entirety of the central zone 20c. This radial supply of the membrane 20 from the chamber 42 to the central zone 20c is shown by arrows 56 in FIGS. 3b and 4b. Thus, regardless of the level of liquid 50 in the reservoir 18 and especially regardless of the orientation of the cigarette 10, the membrane 20 is supplied with liquid homogeneously. The variations in quantity of atomized liquid as the reservoir 18 progressively empties are thus reduced.

In the vertical orientation of the cigarette 10, the lowest part of the reservoir 18 may be situated lower down than the lowest point of the orifice 46.

However, in this configuration, liquid 50 may remain in the reservoir 18 without customary movements of the user enabling the liquid 50 situated lowest down in the reservoir 18 to fill the chamber 42. It is then advantageous that the orifice 46 opens at the lowest part of the reservoir 18 in the vertical orientation of the cigarette 10. Thus, even when the reservoir 18 is not very full, communication between the liquid 50 and the chamber 42 is ensured.

In practice, the reservoir 18 has to periodically supply the chamber 42 so that the latter can, in turn, maintain a liquid film on the central zone 20c of the membrane 20. It has been found that, on average, suction of a user lasts approximately a few seconds, typically 3 seconds. The chamber 42 is dimensioned, notably in terms of its outer diameter, to contain a volume equivalent to 30 to 50 seconds of suction, thus representing more than ten instances of suction. During the period in which a user will carry out these ten instances of suction, the probability that they will modify the orientation of the cigarette 10 is very high, and notably that they will orient the cigarette 10 in a position in which the level 52 of the liquid reaches the chamber 42 at least for the time necessary to fill the chamber 42. The orientations of the cigarette 10 that are shown in FIGS. 3a and 4a are only examples for understanding how the chamber 42 may be filled or not filled by means of the liquid 50 contained in the reservoir 18. In practice, during the use of the cigarette 10, the user regularly modifies the orientation of the cigarette 10 in any intermediate orientation between those shown. Generally, it should be understood that the filling of the chamber 42 can be effected when the level 52 of the liquid 50 reaches the chamber 42 and is interrupted when the level 52 does not reach it.

During the atomization, it has been found that several bubbles of air tend to form on the face 20a of the membrane 20 in the region of the central zone 20c in the liquid film present on the membrane 20 on the side of the reservoir 18, that is to say on the face 20a of the membrane 20. It has been found that the air bubbles do not form in the chamber 42, that is to say on the peripheral part of the membrane 20, but rather only in the region of the central zone 20c. If these air bubbles remain in contact with the membrane 20, the atomization is degraded. The presence of the orifice 46 facing the central zone 20c makes it possible for these air bubbles to be discharged toward the reservoir 18 above the level 52 of liquid. The fact that the air bubbles can be discharged through the orifice 46 makes it possible to not impair the atomization. Thus, in order to improve the atomization, it is advantageous for the orifice 46 to be situated facing the central zone 20c of the membrane 20. It is not necessary to provide an additional orifice opening out into the chamber 42 and enabling the discharge of any air bubbles.

1. An electronic cigarette comprising:
a reservoir containing a liquid capable of being atomized,
a porous membrane configured to atomize the liquid the membrane having the shape of a film having two opposite faces that are distant from one another by the thickness of the membrane the liquid present in the reservoir coming into contact with a first of the two faces in order to pass through the membrane in its thickness,
an actuator configured to cause the membrane to vibrate so as to atomize the liquid as it passes through the membrane,
a chamber disposed between the reservoir and the membrane, the chamber being in communication with the reservoir in order to admit the liquid therein, the chamber extending between two parallel walls, of which a first is formed by the first face the liquid wetting the two walls of the chamber, a thickness of the chamber forming a distance separating the two walls being defined so that the liquid diffuses in the chamber by a capillary action effect such that the liquid is held in contact with the membrane the chamber being in communication with the reservoir by means of an orifice situated facing a central zone of the membrane.

2. The electronic cigarette as claimed in claim 1, wherein a vertical orientation of the electronic cigarette is defined with respect to a user in a standing position drawing in the liquid atomized by the membrane, and in the vertical orientation:
the chamber and the membrane extend substantially vertically,
the chamber is in communication with the reservoir by means of an orifice opening at the lowest part of the reservoir.

3. The electronic cigarette as claimed in claim 1, wherein the chamber has a washer shape extending around the orifice.

4. The electronic cigarette as claimed in claim 1, wherein the chamber has a circular outer contour and wherein the orifice has a circular section that is concentric with the circular contour of the chamber.

5. The electronic cigarette as claimed in claim 1, wherein the actuator is fastened to the membrane and wherein the actuator is pierced in the same dimensions as those of a section of the orifice.

6. The electronic cigarette as claimed in claim 2, wherein the chamber has a washer shape extending around the orifice.

7. The electronic cigarette as claimed in claim 2, wherein the chamber has a circular outer contour and wherein the orifice has a circular section that is concentric with the circular contour of the chamber.

8. The electronic cigarette as claimed in claim 3, wherein the chamber has a circular outer contour and wherein the orifice has a circular section that is concentric with the circular contour of the chamber.

9. The electronic cigarette as claimed in claim 6, wherein the chamber has a circular outer contour and wherein the orifice has a circular section that is concentric with the circular contour of the chamber.

10. The electronic cigarette as claimed in claim 2, wherein the actuator is fastened to the membrane and wherein the actuator is pierced in the same dimensions as those of a section of the orifice.

11. The electronic cigarette as claimed in claim 3, wherein the actuator is fastened to the membrane and wherein the actuator is pierced in the same dimensions as those of a section of the orifice.

12. The electronic cigarette as claimed in claim 6, wherein the actuator is fastened to the membrane and wherein the actuator is pierced in the same dimensions as those of a section of the orifice.

13. The electronic cigarette as claimed in claim 4, wherein the actuator is fastened to the membrane and wherein the actuator is pierced in the same dimensions as those of a section of the orifice.

14. The electronic cigarette as claimed in claim 7, wherein the actuator is fastened to the membrane and wherein the actuator is pierced in the same dimensions as those of a section of the orifice.

15. The electronic cigarette as claimed in claim 8, wherein the actuator is fastened to the membrane and wherein the actuator is pierced in the same dimensions as those of a section of the orifice.

16. The electronic cigarette as claimed in claim 9, wherein the actuator is fastened to the membrane and wherein the actuator is pierced in the same dimensions as those of a section of the orifice.
